(19) United States
(12) Patent Application Publication
(10) Pub. No.: US 2003/0111280 A1
(43) Pub. Date: Jun. 19, 2003

(54) Drive system for an electric vehicle

(76) Inventors: David K. Platner, Shelby, MI (US); Adam Richard Menze, Davenport, IA (US)

Correspondence Address: CARLSON, GASKEY & OLDS, P.C., 400 WEST MAPLE ROAD, SUITE 350, BIRMINGHAM, MI, 48009, US

(21) Appl. No.: 10/025,338

(22) Filed: Dec. 19, 2001

(51) Int. Cl. B60K 1/00

(52) U.S. Cl. 180/65.6

(57) ABSTRACT

An electric vehicle drive assembly includes a rigid axle having opposed wheel hubs driven by a gear set. An electric motor is fixedly mounted to a vehicle frame cross member separate from the axle. The electric motor drives a drive shaft which directly drives an input pinion of the gear set. As the input pinion rotates, it meshes with an outer diameter teeth set of a rotatable ring gear to drive a plurality of planet gears and provide a high reduction ratio. The planet gears are rotated about a stationary sun gear and simultaneously rotate a planet carrier and drive an output shaft attached to the wheel hub.

### BACKGROUND OF THE INVENTION

The present invention relates to an electric motor operated vehicle, and more particularly to a compact motor and reduction transmission arrangement unit for remotely driving a vehicle wheel hub.

There is an increasing demand for the use of electric power driven or electric power assist vehicles. It is important that the motor and its driving transmission can be compact so as to facilitate utilization with generally conventional-type vehicles.

In one conventional arrangement, the motor and transmission are assembled as apart of a driving wheel hub. This may give rise to difficulties in providing both a compact arrangement and the location of a relatively large weight upon the axle and suspension assembly. Such suspension mounted weight results in adverse suspension characteristics and substantially enlarged suspension components.

Another conventional arrangement provides a centrally located electric motor which drives two opposed wheels at the sides of the vehicle by way of a conventional axle and reduction transmission. Although readily applicable to a conventional vehicle layout, these arrangements typically do not provide a high enough speed reduction without additional gear reduction units. Additional gear reductions increase complexity and frictional resistance through out the driveline.

Accordingly, it is desirable to provide a lightweight and compact electric motor drive arrangement that is readily applicable to conventional vehicle arrangements. It is further desirable to provide a high reduction without multiple reduction units.

### SUMMARY OF THE INVENTION

The electric vehicle drive assembly according to the present invention provides a rigid axle having opposed wheel hubs. The axle is supported from the vehicle frame by a suspension system. An electric motor is fixedly mounted to the frame which removes the electric motor from the un-sprung mass of the axle assembly.

In operation, the electric motor drives a drive shaft which directly drives an input pinion of the gear set. As the input pinion rotates, it meshes with the outer diameter teeth of a rotatable ring gear to simultaneously drive each of a plurality of planet gears which mesh with inner diameter teeth extending about the inner perimeter of the rotatable ring gear. The planet gears are rotated about a stationary sun gear and simultaneously rotate a planet carrier. The planet carrier drives an output shaft attached to the wheel hub.

Directly driving the ring gear of a planetary gear set provides an overall greater gear reduction which eliminates additional complex gear reduction sets between the high RPM low torque electric motor and the wheel hub

The present invention therefore provides a lightweight and compact electric motor drive arrangement that is readily applicable to conventional vehicle arrangements.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general phantom top view an exemplary vehicle for use with the present invention;

FIG. 2 is an expanded partial sectional view of an axle assembly of the present invention;

FIG. 3 is an expanded schematic view of a gear set of the planetary gear set of FIG. 2; and

FIG. 4 is an expanded cross-sectional view of the gear set of FIG. 3 taken along the line 4-4.

### DETAILED DESCRIPTION OF THE PREFERRED EMBODIMENT

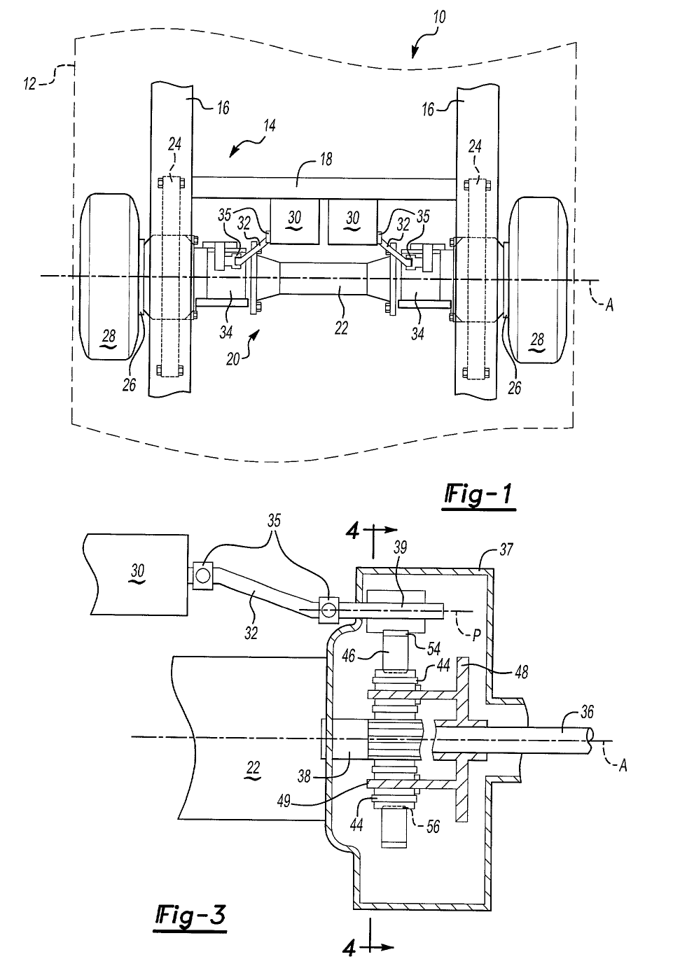

FIG. 1 illustrates a partial phantom view of a vehicle 10 having a body 12 supported upon a frame 14. Preferably, the vehicle is a single drive axle regional haul type vehicle, however, other vehicles will also benefit from the present invention. The frame 14 includes a pair of main longitudinal members 16 and one or more cross members 18 therebetween. It should be understood that although a particular frame arrangement is disclosed in the illustrated embodiment, other frame arrangements will benefit from the present invention.

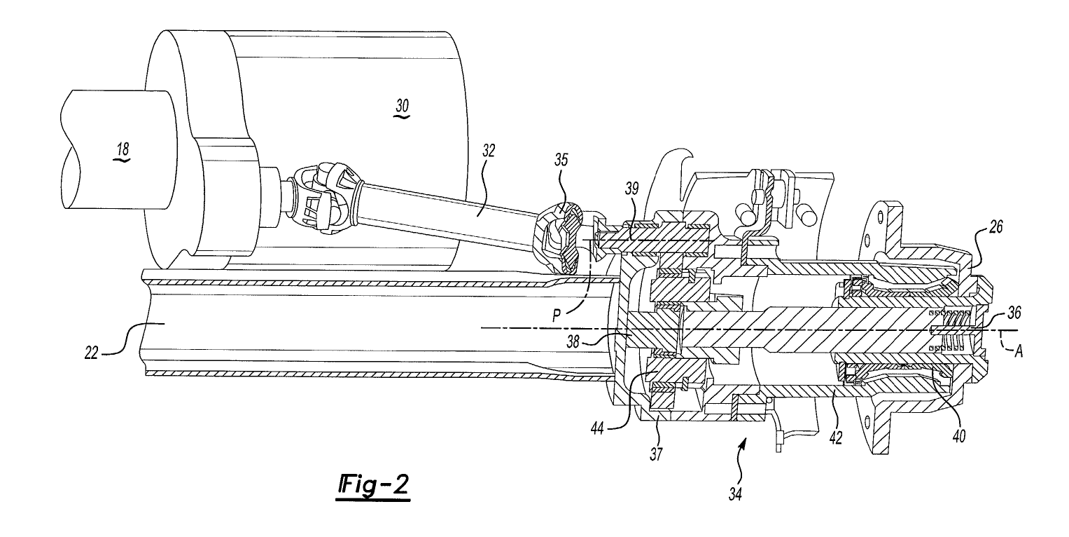

A drive assembly 20 comprises a rigid axle 22 that defines an axis A substantially transverse the longitudinal members 16. Preferably, the axle 22 is a tubular or box axle to provide strength and relatively lightweight (FIG. 2). The axle 22 is supported by a suspension (illustrated schematically at 24) mounted to each main longitudinal member 16. The rigid axle 22 is therefore movable relative to the longitudinal members 16 through the suspension assembly 24 as is well known. The axle 22 supports a wheel hub 26 rotatably mounted to opposed ends of the axle 22 for rotation about an axis A. The wheel hubs 26 each support one or more wheels 28.

An electric motor 30 is fixedly mounted to a frame cross member 18 adjacent each wheel hub 26. Preferably, the electric motor 30 is mounted to the cross member 18 above the axle 22 relative to the ground. That is, the electric motor 30 is not mounted to the axle 22 and isolated from the axle by the suspension system 24. The axle assembly 20 and suspension 24 may thereby be manufactured of relatively light weight components. Moreover, removing the electric motor 30 from the un-sprung mass of the axle assembly 20 provides improved vehicle ride characteristics.

Each electric motor 30 includes a drive shaft 32 to individually drive its respective wheel hub 26 through a gear set 34. The drive shaft 32 preferably includes a jointed connection 35 at each end. The jointed connections 35 such as universal joints, slip shafts, constant velocity joints or the like accommodate relative movement between the electric motor 30 which is fixed to the cross member 18 and the axle assembly 20 which is movable relative thereto upon the suspension system 24.

Referring to FIG. 2, the gear set 34 is mounted to each opposed end of the axle 22 in a gear housing 37 or the like. The gear housing 37 is preferably welded directly to the axle 22. The drive shaft 32 interconnects the electric motor 30 to the gear set 34 through an input pinion 39. The gear set 34 drives the wheel hub 26 through an output shaft 36 or the like.

The gear set 34 is preferably a planetary gear set having a stationary sun gear 38 mounted adjacent the output shaft 36 along axis A. The output shaft 36 is mounted within one or more bearings 40 which are preferably contained within a spindle 42.

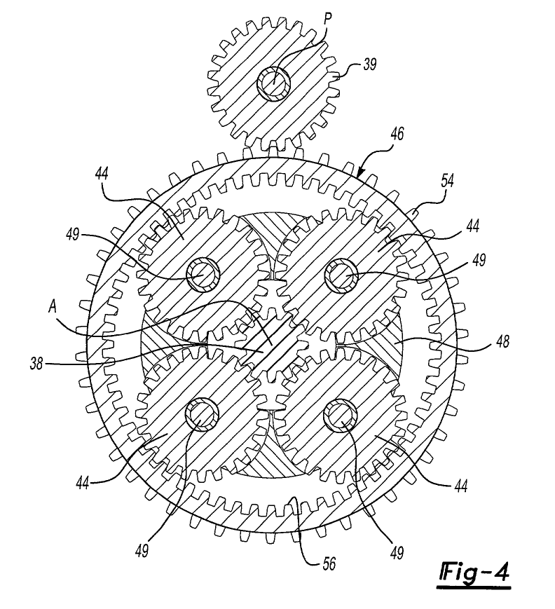

Referring to FIG. 3, the gear set 34 preferably includes the stationary sun gear 38, meshing with planet gears 44 which corresponding mesh with an inner diameter of the rotatable ring gear 46. It should be understood that each rotatable member is preferably mounted upon a bearing or the like as generally known. In a preferred configuration there are three planet gears 44 but it is understood that a different number of planet gears 44 can be used. Each planet gear 44 (FIG. 4) is attached to a planet carrier 48 by a corresponding planet pin 49. The planet carrier 48 is fixed attached to the output shaft 36 through splines or the like.

The input pinion 39 is preferably connected to the drive shaft 32 through the jointed connection 35. The input pinion 39 teeth mesh with corresponding outer diameter teeth 54 extending about the outer perimeter of the rotatable ring gear 46. The input pinion 39 is the drive input to the gear set 34 and defines an axis P substantially parallel to the axis or rotation A. It should be understood that the input pinion 39 may be angled relative to the axis A to provide clearance relative to the axle 22.

In operation, the electric motor 30 drives the drive shaft 32 which directly drives the input pinion 39. As the input pinion 39 rotates, it meshes with the outer diameter teeth 54 of the rotatable ring gear 46 to rotate the ring gear 46 and simultaneously drive each of the planet gears 44 which mesh with inner diameter teeth 56 extending about the inner perimeter of the rotatable ring gear 46. The planet gears 44 are rotated about the stationary sun gear 38 and simultaneously rotate the planet carrier 48. The planet carrier 48 then drives output shaft 36.

Directly driving the ring gear of a planetary gear set provides multiple advantages. Driving the ring gear provides an overall greater gear reduction in the order of 30:1 Further, driving planetary gears about a stationary sun gear provides further gear reduction in the order of 2:1. Of course, various gear reductions may be provided which will benefit from the present invention.

Directly driving the ring gear thereby minimizes or eliminates additional complex gear reduction sets between the high RPM low torque electric motor 30 and the wheel hub 26. Moreover, by providing an independent electric motor 30 to individually drive each hub 26 no differential is required, which decreases the vehicle weight, provides a broader selection of wheel equipment and wheel end features.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An electric vehicle drive assembly comprising:
a suspension system mounted to a vehicle frame;
an axle mounted to said suspension system, said axle defining a first axis;
a wheel hub mounted to said vehicle axle, said wheel hub rotatable about said first axis;
a planetary gear set mounted to said axle to drive said wheel hub;
an electric motor mounted to a member of said vehicle frame, said electric motor mounted substantially parallel to said vehicle axle; and
a drive shaft extending from said electric motor to drive said planetary gear set.

2. The electric vehicle drive assembly as recited in claim 1, wherein said planetary gear set includes a ring gear, said drive shaft driving an outer diameter teeth set about an outer diameter of said ring gear.

3. The electric vehicle drive assembly as recited in claim 2, wherein said planetary gear set includes an input pinion meshed with said outer diameter teeth set, said input gear pinion by said drive shaft.

4. The electric vehicle drive assembly as recited in claim 3, wherein said input pinion defines a pinion axis substantially parallel to said first axis.

5. The electric vehicle drive assembly as recited in claim 1, wherein said electric motor is mounted offset and substantially parallel to said first axis.

6. The electric vehicle drive assembly as recited in claim 1, wherein said planetary gear set includes a stationary sun gear.

7. The electric vehicle drive assembly as recited in claim 1, wherein said planetary gear set includes a plurality of planet gears rotatably mounted to a planet carrier, said planet carrier driving an out put shaft to said wheel hub.

8. An electric vehicle drive assembly comprising:
a suspension system mounted to a vehicle frame;
an axle mounted to said suspension system, said axle defining a first axis;
a first and second wheel hub mounted to opposed ends of said axle, said first and second wheel hub rotatable about said first axis;
a first planetary gear set mounted to said axle to drive said first wheel hub, said first planetary gear set having a first ring gear;
a second planetary gear set mounted to said axle to drive said second wheel hub said second planetary gear set having a second ring gear;
a first and second electric motor mounted to a cross member of said vehicle frame, said first and second electric motor mounted substantially parallel to said vehicle axle;
a first input pinion engageable with an outer diameter of said first ring gear;
a first drive shaft extending from said first electric motor to drive said first input pinion;
a second input pinion engageable with an outer diameter of said second ring gear; and
a second drive shaft extending from said second electric motor to drive said second input pinion.

9. The electric vehicle drive assembly as recited in claim 8, wherein said input pinion defines an axis substantially parallel to said first axis.

10. The electric vehicle drive assembly as recited in claim 8, wherein said first and second electric motor are mounted substantially above said axle relative the ground.

11. The electric vehicle drive assembly as recited in claim 8, wherein each of said first and second planetary gear sets include a stationary sun gear.

12. The electric vehicle drive assembly as recited in claim 8, further comprising
a first plurality of planet gears engageable with an inner diameter of said first ring gear;
a first planet carrier rotatbly mounting said first plurality of planet gears;
a first out put shaft driven by said planet carrier, said first output shaft driving said first wheel hub;
a second plurality of planet gears engageable with an inner diameter of said second ring gear;
a second planet carrier rotatbly mounting said second plurality of planet gears;
a second out put shaft driven by said second planet carrier, said second output shaft driving said second wheel hub;
